(19) United States
(12) Patent Application Publication
(10) Pub. No.: US 2015/0201051 A1
(43) Pub. Date: Jul. 16, 2015

(54) Mobile electronic device or device case with integrated earpiece storage

(71) Applicant: Joseph Antonio Belli, Vacaville, CA (US)

(72) Inventor: Joseph Antonio Belli, Vacaville, CA (US)

(21) Appl. No.: 14/250,672

(22) Filed: Apr. 11, 2014

Related U.S. Application Data
(60) Provisional application No. 61/927,798, filed on Jan. 15, 2014.

(51) Int. Cl. H04M 1/02; H04M 1/60

(52) U.S. Cl. CPC H04M 1/0258; H04M 1/6066

(57) ABSTRACT

A mobile electronic device or device case with integrated earpiece storage, which enables the user to store and recharge both the mobile electronic device and the earpiece as a single unit. The earpiece is seamlessly stored in a specialized compartment. The compartment is flush with the surface of the device case when closed or in a storage position, and optionally the exterior of the earpiece may form a portion of the closed exterior of the case.

### CROSS-REFERENCE TO RELATED APPLICATIONS

This Application claims priority to U.S. Provisional Application No. 61/927798, filed Jan. 15, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to accessories for personal electronic devices and accessories, and in particular to a mobile electronic device or device case with integrated earpiece storage. A variety of medium-range wireless protocols, exemplified by Bluetooth—, have transformed the use of cellular telephones and similar mobile electronic devices. Unfortunately, the earpiece is a separate device from the mobile electronic device and must be stored and recharged separately. Furthermore, the earpiece must be synchronized with the mobile electronic device each time the user chooses to use the earpiece. A mobile electronic device or device case with integrated earpiece storage, enabling the user to store and recharge both the cellular telephone and the earpiece as a single unit, would resolve these problems.

### SUMMARY OF THE INVENTION

Accordingly, the invention is directed to a mobile electronic device or device case with integrated earpiece storage, enabling the user to store and recharge both the mobile electronic device and the earpiece as a single unit. The earpiece is seamlessly stored in a specialized compartment. The compartment is flush with the surface of the device case when closed or in a storage position, and optionally the exterior of the earpiece may form a portion of the closed exterior of the device case.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrates two embodiments of the invention and, together with the description, serve to explain the principles of the invention.

FIG. 1 is a rear view of the first exemplary embodiment with the earpiece in the stored position, displaying the device case 10, and the earpiece 11.

FIG. 2 is a front view of the earpiece component of the first exemplary embodiment in the closed and opened positions, displaying the earpiece 11, the seams 12, the speaker 13, and the microphone 14.

FIG. 3 is a rear view of the second exemplary embodiment with the earpiece in the stored position, and a front view of the earpiece component of the second exemplary embodiment, displaying the device case 10, the earpiece 11, the speaker 13, the microphone 14, and the open point 30.

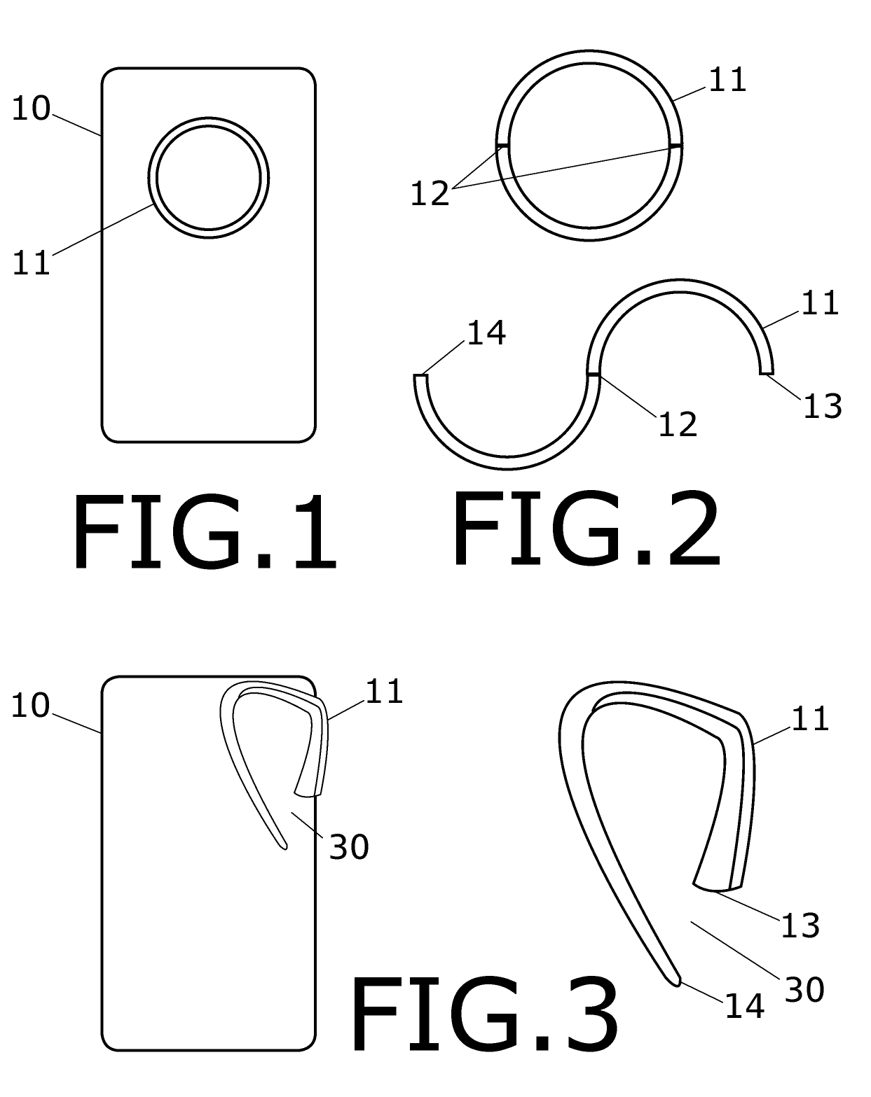

### DETAILED DESCRIPTION OF THE INVENTION

Referring now to the invention in more detail, the invention is directed to a mobile electronic device or device case 10 with integrated earpiece storage, enabling the user to store and recharge both the mobile electronic device and the earpiece 11 as a single unit. The case 10 is understood as either the integral external casing of the mobile electronic device itself or an external carrying case, cover, sleeve, or protector, conforming a mobile electronic device. The earpiece 11 is seamlessly stored in a specialized compartment. The compartment is flush with the surface of the device case 10 when closed or in a storage position, and optionally the exterior of the earpiece 11 may form a portion of the closed exterior of the case 10.

The first exemplary embodiment features a device case 10 or a device exterior casing for a mobile electronic device. The family of contemplated mobile electronic devices and cases therefor includes laptop and notebook computers, tablet devices, smartphones, other mobile telephones, Personal Data Assistant, portable music player, and the like. The family of contemplated earpiece devices include earpieces, headsets, headphones, earbuds, and the like. The first exemplary embodiment also features a ring-shaped earpiece 11, with two seams 12 at the three o'clock and nine o'clock positions, separating the earpiece 11 into upper and lower halves. One of the two seams 12 conceals a pin, around which the lower half may be rotated 180° to create an S-shaped configuration. The other seam 12 conceals a speaker 13 in the upper half, and a microphone 14 in the lower half.

The second exemplary embodiment features a device case 10 and an earpiece 11 which is roughly triangular in shape, with an open point 30. At the open point, one of the arms of the triangle terminates in a speaker 13, and the other arm terminates in a microphone 14. At a second point of the triangle, the point is curved and contoured to conform to an upper corner of the device case 10.

For both exemplary embodiments, the storage compartment is a recess in the edge surface or rear surface of the device case 10 which conforms closely to the shape of the earpiece 11. Recharging may be accomplished with a small pin in the compartment, which inserts into a corresponding recharging port in the surface of the earpiece 11 when it has been stored. An alternate embodiment, which recharges the earpiece 11 through inductive coupling, is also contemplated.

To use the first exemplary embodiment, the user removes the earpiece 11 from the storage compartment, opens it into an S-shaped configuration, and places it on the ear such that the speaker 13 is close to the ear, and the microphone 14 is close to the mouth. To use the second exemplary embodiment, the user follows the same procedure except that the earpiece 11 does not open into an S-shaped configuration.

The device case 10 and the earpiece 11 are preferably manufactured from rigid, durable materials such as plastic and acrylic polymers. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A system of a mobile device case and earpiece comprising a case and an earpiece; said earpiece being capable of being stored on or within said case; and said earpiece having an integral speaker and a microphone affixed therein.

2. The system of a mobile device case and earpiece of claim 1 wherein said case is the integral external casing of a mobile electronic device.

3. The system of a mobile device case and earpiece of claim 1 wherein said case is any of the group of a carry case, cover, sleeve, or protector conforming to a mobile electronic device.

4. The system of a mobile device case and earpiece of claim 1 wherein said earpiece is configured so as to be moved between a circular storage position and an S-shaped use position; wherein said earpiece further comprises a pair of seams, said pair of seams being located at the 3 o'clock and 9 o'clock positions of said earpiece when said earpiece is in said circular storage position; and wherein one of said pair of seams forms a joint about which said earpiece may be rotated 180° into said S-shaped use position, and the other of said pair of seams forms a point where said earpiece may be separated.

5. The system of a mobile device case and earpiece of claim 1 wherein said earpiece is about triangular in shape, and said earpiece having an open point.

6. The system of a mobile device case and earpiece of claim 4 wherein said case is the integral external casing of a mobile electronic device.

7. The system of a mobile device case and earpiece of claim 4 wherein said case is any of the group of a carry case, cover, sleeve, or protector conforming to a mobile electronic device.

8. The system of a mobile device case and earpiece of claim 5 wherein said case is the integral external casing of a mobile electronic device.

9. The system of a mobile device case and earpiece of claim 5 wherein said case is any of the group of a carry case, cover, sleeve, or protector conforming to a mobile electronic device.

10. The system of a mobile device case and earpiece of claim 1 wherein said earpiece is configured so as to press into the rear surface of said case and be removably retained therein.

11. The system of a mobile device case and earpiece of claim 1 wherein said earpiece is configured so as to press into the edge surface of said case and be removably retained therein.

12. The system of a mobile device case and earpiece of claim 4 wherein said earpiece is configured so as to press into the rear surface of said case and be removably retained therein.

13. The system of a mobile device case and earpiece of claim 4 wherein said earpiece is configured so as to press into the edge surface of said case and be removably retained therein.

14. The system of a mobile device case and earpiece of claim 5 wherein said earpiece is configured so as to press into the rear surface of said case and be removably retained therein.

15. The system of a mobile device case and earpiece of claim 5 wherein said earpiece is configured so as to press into the edge surface of said case and be removably retained therein.

16. The system of a mobile device case and earpiece of claim 12 wherein said case is the integral external casing of a mobile electronic device.

17. The system of a mobile device case and earpiece of claim 12 wherein said case is any of the group of a carry case, cover, sleeve, or protector conforming to a mobile electronic device.

18. The system of a mobile device case and earpiece of claim 13 wherein said case is the integral external casing of a mobile electronic device.

19. The system of a mobile device case and earpiece of claim 13 wherein said case is any of the group of a carry case, cover, sleeve, or protector conforming to a mobile electronic device.

20. An earpiece, said earpiece having an integral speaker and a microphone affixed therein; said earpiece being configured so as to be moved between a circular storage position and an S-shaped use position; said earpiece further comprising a pair of seams, said pair of seams being located at the 3 o'clock and 9 o'clock positions of said earpiece when said earpiece is in said circular storage position; and wherein one of said pair of seams forms a joint about which said earpiece may be rotated 180° into said S-shaped use position, and the other of said pair of seams forms a point where said earpiece may be separated.
